(19) United States
(12) Patent Application Publication
(10) Pub. No.: US 2013/0144620 A1
(43) Pub. Date: Jun. 6, 2013

(54) METHOD, SYSTEM AND PROGRAM FOR VERIFYING THE AUTHENTICITY OF A WEBSITE USING A RELIABLE TELECOMMUNICATION CHANNEL AND PRE-LOGIN MESSAGE

(71) Applicants: Richard J. Lipton, Atlanta, GA (US); Shoshana K. Loeb, Philadelphia, PA (US); Thimios Panagos, Madison, NJ (US)

(72) Inventors: Richard J. Lipton, Atlanta, GA (US); Shoshana K. Loeb, Philadelphia, PA (US); Thimios Panagos, Madison, NJ (US)

(73) Assignee: TELCORDIA TECHNOLOGIES, INC., Piscataway, NJ (US)

(21) Appl. No.: 13/312,292

(22) Filed: Dec. 6, 2011

(51) Int. Cl. G06F 21/00; G10L 17/00

(52) U.S. Cl. 704/246; 726/26; 704/E17.001

(57) ABSTRACT

Various embodiments of the present invention for validating the authenticity of a website are provided. An example of a method according to the present invention comprises providing a website having an artifact, receiving a communication from a user, at a service provider, for validating the website associated with a service provider, inquiring from the user a description of the artifact comparing the artifact on the website with the description of the artifact from the user and generating a indication to the user based upon the comparing. The communication is over a first communication channel and the website is accessed over a second communication channel. The first communication channel is different than the second. The artifact can be displayed after a user session is identified.

### FIELD OF THE INVENTION

This invention relates to communication systems. More particularly, this invention relates to methods, systems and programs for authenticating a website.

### BACKGROUND

The Internet has exposed users to multiple risks including phishing and fake websites that try to extract personal information, such as credit card numbers, or install malicious applications on users' computers.

A website should be authenticated prior to the user entering personal information. One method of verifying the authenticity of a website uses a secure HTTP connections (e.g., HTTPS) and company logos. For example, the Comodo Verification Engine (http://www.vengine.com/) is a browser plug-in that can verify company logos appearing on websites and check SSL certificates associated with HTTPS sessions.

This requires either a secure HTTP connection (e.g., rely on cryptographic methods) or the registration of website logos and other artifacts with specific databases.

### SUMMARY OF THE INVENTION

Accordingly, disclosed is a method for validating the authenticity of a website. The method comprises providing a website, from a service provider, the website having an artifact, receiving a communication from a user, at a service provider, for validating the website associated with a service provider, inquiring from the user an indication of the artifact, comparing the artifact on the website with the indication of the artifact from the user and generating an indication to the user based upon the comparison.

Also disclosed is a system for validating the authenticity of a website comprising a plurality of host servers configured to receive a request for one of a plurality of websites from a user and to transmit the requested website to the user in response, an interactive voice recognition device configured to receive a call from a user, to interact with the user to authenticate a website, where the website has an artifact, to inquire from the user a description of the artifact and to receive the description of the artifact in response and a controller configured to compare the artifact on the website with the description of the artifact from the user and generate an indication to the user based upon the comparison. Each host server hosts a plurality of websites. The request and response is transmitted via a first communication channel. The call is transmitted via a second communication channel,

Also disclosed is a computer readable storage medium having a program for causing a computer to execute a method for validating an authenticity of a website. The method comprises receiving a description of an artifact on a website via a first communication channel, the website being displayed on user equipment via a second communication channel, comparing the artifact on the website with the description of the artifact and generating an indication to the user based upon the comparing.

Also disclosed is a computer readable storage medium having a program for causing a computer to execute a method for validating the authenticity of a website. The method comprises displaying a user input interface on the website, receiving a description of information input into the user input interface and searching a plurality of host servers for matching information. If there is a match, the method further comprises determining a corresponding host server and comparing the corresponding host server with a host server that is hosting the website. If the corresponding host server is the host server that is hosting the website, displaying an artifact on the website, receiving a description of the artifact on the website, comparing the displayed artifact with the description of the artifact and generating an indication to the user based upon the comparing of the artifact on the website with the description of the artifact.

### BRIEF DESCRIPTION OF THE DRAWINGS

These and other features, benefits, and advantages of the present invention will become apparent by reference to the following figures, with like reference numbers referring to like structures across the views, wherein:

FIG. 1 illustrates an exemplary system for verifying the authenticity of a website in accordance with the invention;

FIG. 1A illustrates another exemplary system for verifying the authenticity of a website; in accordance with the invention;

FIGS. 2 and 3 illustrate flow charts for an exemplary method for verifying the authenticity of a website according to the invention;

FIGS. 4 and 5 illustrate flow charts for another exemplary method for verifying the authenticity of a website according to the invention;

FIGS. 6 and 6A illustrate additional exemplary systems for verifying the authenticity of a website in accordance with the invention; and

FIGS. 7 and 8 illustrate flow charts for an exemplary method for verifying the authenticity of a website according to the invention.

### DETAILED DESCRIPTION OF THE INVENTION

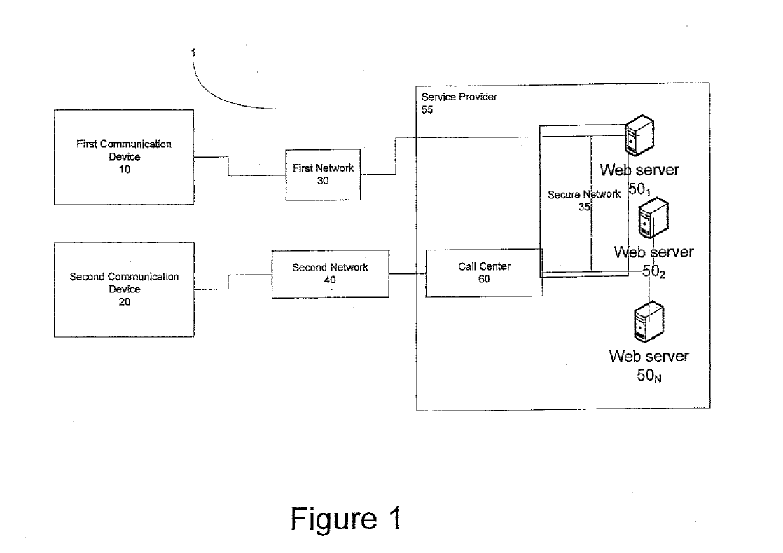

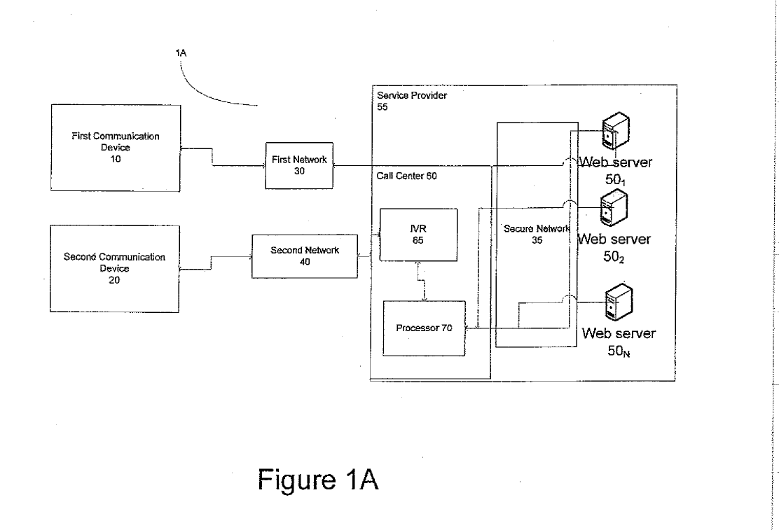

FIG. 1 illustrates an exemplary system 1 for verifying the authenticity of a website.

The system 1 does not need or require a secure HTTP connection. Additionally, the system 1 does not require any registration of website artifacts with a database. The system 1 uses a reliable channel of communication to validate the identity of the website/service provider using non cryptographic methods.

The user accesses a website using a first communication device 10 via a first network 30. The first communication device 10 can be, but not limited to, a desktop computer, a laptop, cellular telephone, or any device configured to access a website, e.g., an IP network enabled device. The first network 30 is an IP network.

Subsequently, the user calls a call center 60 associated with the service provider 55 to verify the website using a second communication device 20 via a second network 40. The second communication device 20 can be, but is not limited to, a wired or wireless telephone, such as a mobile telephone or any device configured for voice communication. The second communication device 20 can also be a computer peripheral configured to communicate using voice over the interne protocol (VOIP). The second network 40 can be a telephone network including a cellular network.

The service provider 55 includes a call center 60 and a plurality of web servers 50_{N}. For purpose of the description the web servers will be collectively referenced as “web servers 50”. The call center 60 can have a live operator. Alternatively, the call center 60 can include an automated voice recognition and synthesis system such as an Interactive Voice Response system (“IVR 65”) and a processor 70. The IVR 65 can also be outsourced to a third party. Once the voice is recognized, the information can be forwarded to the processor 70. FIG. 1A illustrates diagram of the system 1A having an IVR 65 and a processor 70 in the call center 60. The automated voice recognition and synthesis system 65 can be the Avaya Interactive Voice Response system. The call center 60 accesses the web servers 50 using an internal secure network 35.

Each web server 50 hosts one or more websites. A service provider 55 can be the owner of the website. Additionally, the service provider 55 can be a third party whom the owner outsources the management and maintenance of the website. Additionally, the service provider 55 can be an internet service provider (ISP) or other entity that hosts websites using servers. The call center 60 is identified by a telephone number or IP address. This telephone number or IP address is advertised to users of the website. Additionally, the telephone number is provided to a user when a user registers with a website or service provider.

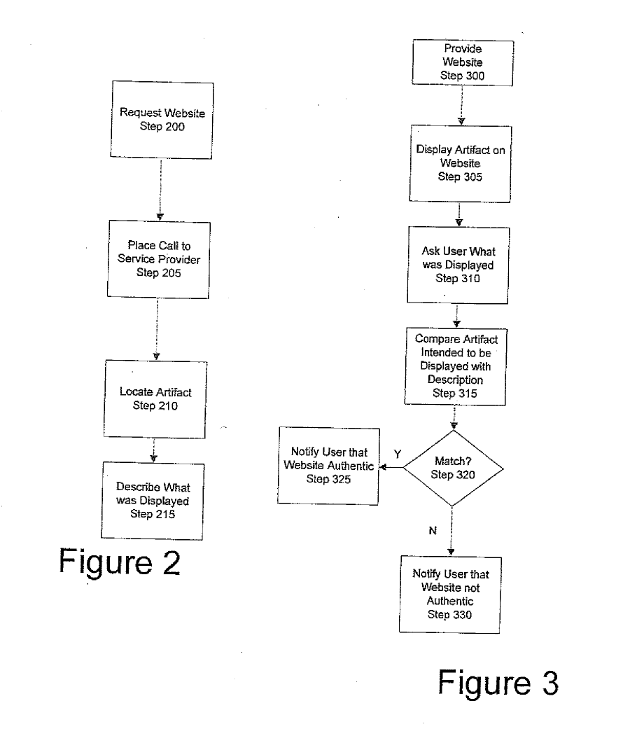

FIGS. 2 and 3 illustrate flow charts for an exemplary method for verifying the authenticity of a website according to the invention. FIG. 2 illustrates the flow chart for the user and FIG. 3 illustrates the flow chart for the service provider 55.

At step 200, the user requests a website using the first communication device 10. The request is via the first network 30. The user can either enter a universal resource locator (URL) for the website or the user can click on a link of the website. The website link can be located on another website. At step 300, the service provider 300 provides the website. The website includes an artifact (step 305). For the purpose of this application the term website refers to a homepage and any additional links associated with a particular owner. The artifact can be, but is not limited to, a message, number string, image, or photograph. The artifact is located in a preset location. The artifact can be located on the homepage. Alternatively, the artifact can be located on a sub-page, where the user will have to click on a link or a tab on the homepage to display the page in which the artifact is located. The artifact is unique to the current user session. The artifact can be randomly selected. Alternatively, the artifact can be common to all sessions. Specifically, the service provider 55 can use a dedicated artifact that is specific to the website, and is always used when the website is displayed.

Before logging in to the website with a user login and password, the user calls a preset phone number to validate that the website is indeed the one belonging to the expected owner, at step 205. The URL can be intercepted and a corrupted website can be displayed. To confirm that the website that is being displayed is the correct website, the user authenticates the website using a different communication channel (via the second network 40). The call is placed using the second communication device 20 while the website is displayed on the first communication device 10.

When the call center 60 for the service provider 55 receives the call, the user is asked to describe the artifact, at step 310. The inquiry can be from a live operator. Alternatively, the IVR 65 can provide the inquiry to the user. The operator will advise the user where the artifact should be located on the website. As described above, the artifact can be located on a sub-page, thus the operator/IVR 65 will instruct the user to click on the specific link or tab to open the page having the artifact.

Once the user locates the artifact (step 210), the user describes the artifact to the operator (or IVR 65) at step 215. At step 315, the operator compares the description of the artifact, by the user, with the actual artifact displayed. If the call center 60 includes an IVR 65, a processor 70 compares the user's description of the artifact with a description of the actual artifact. The processor 70 includes a program of instructions for executing the functionality described herein. The program is stored in a storage device of the processor 70. The processor 70 receives the user's description of the artifact from the IVR 65. The operator (or processor 70) obtains a description of the actual artifact that was displayed by accessing the appropriate web server 50 using the internal secure network 35. This comparison is to check whether the website indeed generated the artifact identified by the user.

At decision step 320, the operator (or processor 70) determines if the two match. If the described artifact was indeed generated by the website (“Y” at decision step 320), the operator/processor 70 generates an indication to notify the user on the second communication device 20 that the user accessed the authentic website at step 325. The processor 70 will forward the notification to the NR 65. The IVR 65 relays the notification to the user. Otherwise (“N” at decision step 320), the user is informed to navigate away from the false website at step 330. The operator/processor 70 generates an indication to notify the user on the second communication device 20 that the user can accessed a spoofed or unauthorized website.

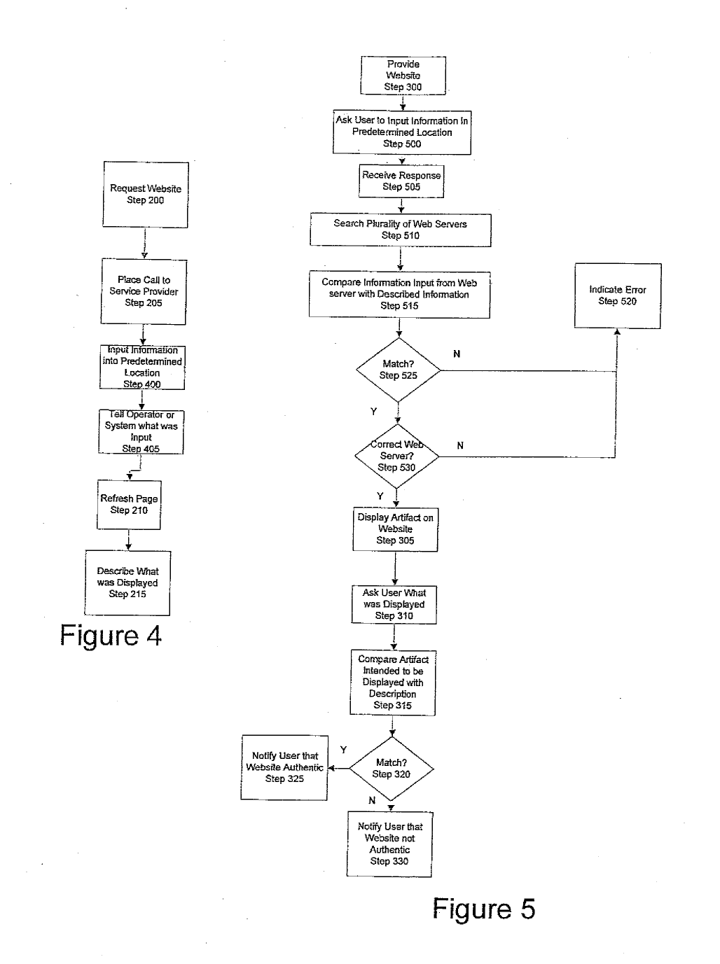

FIGS. 4 and 5 illustrate flow charts for another exemplary method for verifying the authenticity of a website according to the invention. FIG. 4 illustrates the flow chart for the user and FIG. 5 illustrates the flow chart for the service provider 55. Several steps of the exemplary method illustrated in FIGS. 4 and 5 are the same as depicted in FIGS. 2 and 3 and therefore, will not be described again in detail. These steps are labeled with the same number.

At step 200, the user issues a request for a website using the first communication device 10. In response to this request, the service provider 55 displays the website at step 300. Instead of the website initially having the artifact, the website includes a user input section. The user input section can be an HTML form. The user input section is configured to allow a user to input a string of text. The user input section is located in a predetermined location. This location is fixed. The string of text is used by the operator/processor 70 to identify the Internet session. However, since the string of text is input prior to authentication of the website, the string of text should not include any personal information of the user.

Before logging in to the website using personal information, the user calls a preset phone number to validate that the website is indeed the one belonging to the expected owner using the second communication device 20, at step 205. In response to the call, an operator/IVR 65 instructs the user to input information into the user input section and read or describe the entered information using the second communication device 20 at step 500.

At step 400, the user enters information and submits this information to the website and waits for the reply. Additionally, at step 405, the user describes the entered information, e.g., by letter or number. At step 505, the operator/IVR 65 receives the user's description of the entered information. The description is forwarded to the processor 70 via the IVR 65. Using the received information, the operator/processor 70 identifies the user session at step 510, by searching each of the plurality of web servers for input information entered by the user. The operator/processor 70 interacts with the web servers 50 using the internal secure network 35, e.g., back-end infrastructure. At step 515, the operator/processor 70 retrieves the information from a web server 50 and compares the retrieved information with the description. If there is a match (“Y” at decision step 525), the session is identified, and the operator/IVR 65 determines if the correct web server had the described information at step 530. If there is no match, (“N” at step 525), the operator/processor 70 indicates an error at step 520 (processor 70 forwards the indication to the IVR 65 and the IVR 65 relays the indication to the user). If a wrong web server had the input information (“N” at decision step 530), the operator/processor 70 indicates that an error occurs in a similar manner as described above. In other words, if an incorrect host web server received the user's response, there is a question of authenticity. For example, if web server 1 is the host of website www.xyz.com and web server 2, associated with a different website, receives the information, the operator/IVR 65 will indicate an error at step 520. If the correct host web server received the user input, the operator/processor 70 compares the information input extracted or retrieved from the correct web server, e.g., 50₁ with the user's description of the information at step 525. If there is a match (“Y” at decision step 525) and (“Y” at decision step 530), the session is correctly identified and at the correct host and the service provider 55 inserts the artifact (e.g., message, ID string, image or photograph) into the website at step 305. The artifact is unique to the current user session. The artifact will appear to be a reply to the user's input. For example, the processor 70 can cause the artifact to be inserted in the website. The processor 70 can use a random number generator to create the artifact.

The user may have to refresh the website to see the artifact at step 410. The user is asked to describe the artifact, at step 310. The operator/IVR 65 will advise the user where the artifact should be located on the website.

Once the user locates the artifact (step 210) or refreshes the website (step 410), the user describes the artifact in words to the operator (or IVR 65) at step 215. At step 315, the operator compares the description of the artifact, by the user, with the actual artifact displayed. If the call center 60 includes an IVR 65, a processor 70 compares the user's description of the artifact with a description of the actual artifact. The processor 70 will include a program having instructions for causing the processor 70 to perform the functionality described herein. Since the artifact was specifically created for the session, the operator/processor 70 knows the actual artifact. This comparison is to check whether the website indeed generated the artifact identified by the user.

At decision step 320, the operator (or processor 70) determines if the two match. Alternatively, the functionality can be implemented using modules. If the described artifact was indeed generated by the website (“Y” at decision step 320), the service provider informs the user on the second communication device 20 that the user accessed the authentic website at step 325. Otherwise (“N” at decision step 320), the user is informed to navigate away from the false website at step 330.

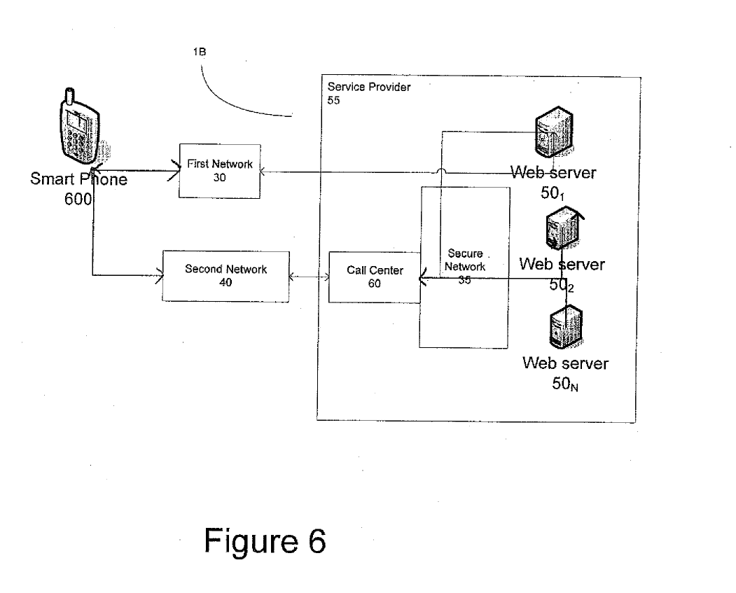

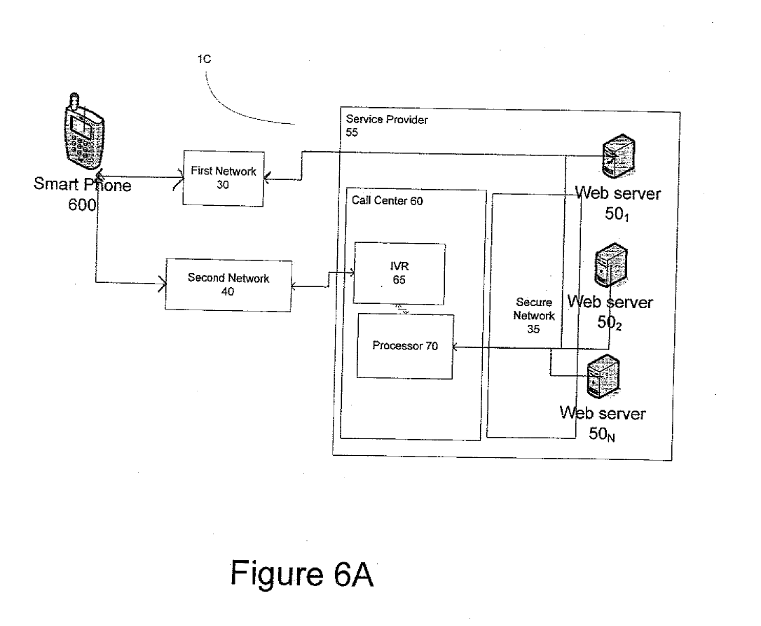

FIG. 6 illustrates system 1B for verifying the authenticity of a website. The exemplary systems 1 and 1A as depicted in FIGS. 1 and 1A have two separate communication devices 10, 20; a first communication device 10 for requesting and displaying a website and a second communication device 20 for placing a separate call to the service provider 55. However, in the system 1B, only one communication device is used, e.g., a smart phone 600. The smart phone 600 simultaneously supports both data and voice communication. The user can access a specific website and place a call to the service provider 55 simultaneously. In system 1B, the service provider 55 (operator/IVR 65 and processor 70, as depicted in FIG. 6A) can identify the website session the user on the smart phone 600 is associated with, without requiring any additional user input, e.g., eliminates user steps 400-405 and service provider steps 500-530.

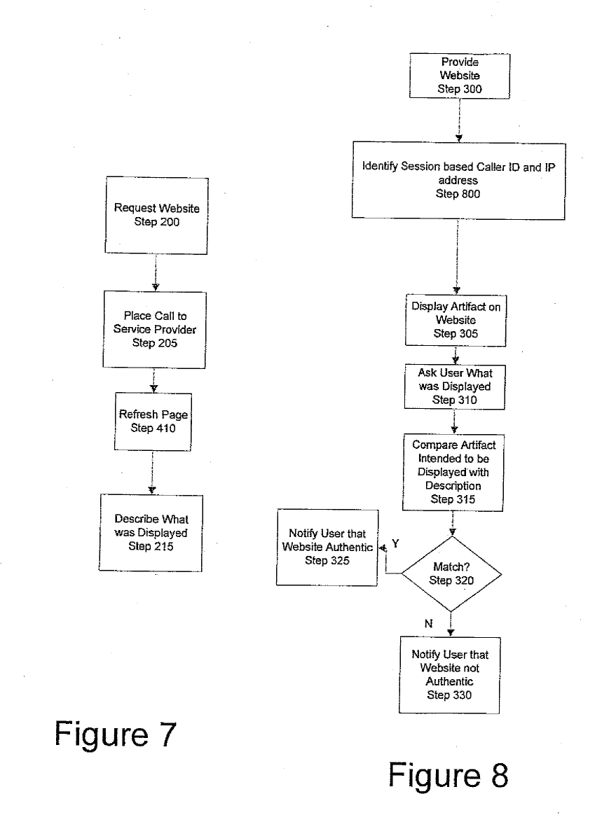

FIGS. 7 and 8 illustrate flow charts for an exemplary method for verifying the authenticity of a website according to the invention. FIG. 7 illustrates the flow chart for the user and FIG. 8 illustrates the flow chart for the service provider 55. Several steps of the exemplary method illustrated in FIGS. 7 and 8 are the same as depicted in FIGS. 4 and 5 and therefore, will not be described again in detail. These steps are labeled with the same number.

At step 200, the user issues a request for a website using the smart phone 600. In response to this request, the service provider 55 displays the website at step 300. At this time, the website does not have an artifact yet. At step 205, the user places a call to the service provider 55 (call center 60) using the smart phone 600. When the call center 60 (operator/IVR 65) receives the call, it identifies the web session at step 800. Specifically, the operator/IVR 65 uses the information from the request for the website, i.e., IP address to correlate the session with the smart phone 600. The “http request” includes an IP address of the smart phone 600. This IP address among other attributes is used to identify the session. Once the session is identified, the operator/IVR 65 causes the artifact to be displayed on the website at step 305. The remaining steps are the same as described above with respect to FIGS. 4 and 5 and therefore, will not be described in detail again.

As described above, when the user views a specific website, prior to entering any login information, the user places a call to a call center 60 associated with the website, however, if the telephone number or identifier of the call center 60 is stored in memory of the device, the smart phone 600 can automatically place the call once the website is displayed. Specifically, if the smart phone 600 detects that a website is displayed, the smart phone 600 automatically retrieves the associated telephone number and establishes a link or connection with the call center 60 (e.g., operator/IVR 65). This can be done via a custom application running on the device or through some other means.

Alternatively, the call center 60 can automatically call a predetermined communication device upon receipt of a request for the display of a website. The phone number or IP address of a communication device can be registered with the call center when the user registers with the website. For example, when the user registers with a website www.xyz.com, and receives a login name and password, the user can also register a communication device for authenticating the website.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as “communication devices” “call center” “modules” “service provider” or “system.”

Various aspects of the present disclosure may be embodied as a program, software, or computer instructions embodied or stored in a computer or machine usable or readable medium, which causes the computer or machine to perform the steps of the method when executed on the computer, processor 70, and/or machine. A computer readable medium, tangibly embodying a program of instructions executable by the machine to perform various functionalities and methods described in the present disclosure is also provided.

The communication devices, service provider, call center, system and method of the present disclosure may be implemented and run on a general-purpose computer or special-purpose computer system. The computer system may be any type of known or will be known systems such as, but not limited to, a virtual computer system and may typically include a processor 70, memory device, a storage device, input/output devices, internal buses, and/or a communications interface for communicating with other computer systems in conjunction with communication hardware and software, etc.

The computer readable medium could be a computer readable storage medium or a computer readable signal medium. Regarding a computer readable storage medium, it may be, for example, a magnetic, optical, electronic, electromagnetic, infrared, or semiconductor system, apparatus, or device, or any suitable combination of the foregoing; however, the computer readable storage medium is not limited to these examples. Additional particular examples of the computer readable storage medium can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an electrical connection having one or more wires, an optical fiber, an optical storage device, or any appropriate combination of the foregoing; however, the computer readable storage medium is also not limited to these examples. Any tangible medium that can contain, or store a program for use by or in connection with an instruction execution system, apparatus, or device could be a computer readable storage medium.

The terms “communication devices” and “network” as may be used in the present disclosure may include a variety of combinations of fixed and/or portable computer hardware, software, peripherals, and storage devices. The system may include a plurality of individual components that are networked or otherwise linked to perform collaboratively, or may include one or more stand-alone components. The hardware and software components of the computer system of the present application may include and may be included within fixed and portable devices such as desktop, laptop, and/or server, and network of servers (cloud). A module may be a component of a device, software, program, or system that implements some “functionality”, which can be embodied as software, hardware, firmware, electronic circuitry, or etc.

The above description provides illustrative examples and it should not be construed that the present invention is limited to these particular examples. Thus, various changes and modifications may be effected by one skilled in the art without departing from the spirit or scope of the invention as defined in the appended claims.

What is claimed is:

1. A method for validating the authenticity of a website comprising:
providing a website, from a service provider, the website having an artifact;
receiving a communication from a user, at a service provider, for validating the website associated with a service provider;
inquiring from the user a description of the artifact;
comparing the artifact on the website with the description of the artifact from the user; and
generating an indication to the user based upon the comparing.

2. The method for validating the authenticity of a website according to claim 1, wherein the communication is over a first communication channel and the website is accessed using a second communication channel, the first communication channel being different than the second.

3. The method for validating the authenticity of a website according to claim 2, wherein the first communication channel is a telephone network.

4. The method for validating the authenticity of a website according to claim 3, further comprising providing to the user a telephone number for the service provider.

5. The method for validating the authenticity of a website according to claim 1, wherein the artifact is randomly generated.

6. The method for validating the authenticity of a website according to claim 1, wherein the artifact is unique to a user session.

7. The method for validating the authenticity of a website according to claim 1, wherein the artifact is predetermined for the website and is common to all user sessions.

8. The method for validating the authenticity of a website according to claim 1, wherein the artifact is selected from a group consisting of a message, an identification string and an image.

9. The method for validating the authenticity of a website according to claim 1, wherein the artifact is positioned in a dedicated location for authenticating the website, the user being instructed of the dedicated location during the inquiring.

10. The method for validating the authenticity of a website according to claim 1, wherein the inquiring being performed by an interactive voice recognition device.

11. The method for validating the authenticity of a website according to claim 1, further comprising
displaying a user input interface on the website;
instructing the user to input information into the user input interface;
receiving, via the website, the information;
receiving, via the communication a description of the information input via the website; and
determining if the information input via the website matches the description of the information received via the communication, wherein if there is a match, the artifact is displayed on the website.

12. The method for validating the authenticity of a website according to claim 11, wherein the determining comprises:
searching a plurality of host servers for matching information, if there is a match,
determining a corresponding host server; and
comparing the corresponding host server with a host server that is hosting the website.

13. The method for validating the authenticity of a website according to claim 1, wherein the communication is automatically generated by a mobile communication device when the website is displaying using a predetermined telephone number.

14. The method for validating the authenticity of a website according to claim 1, wherein the communication is automatically generated by a mobile communication device when the website is displaying using a predetermined communication channel that is different from a communication channel used for accessing the website.

15. The method for validating the authenticity of a website according to claim 14, wherein the artifact is displayed when the communication is received from the mobile communication device.

16. A system for validating the authenticity of a website comprising:
a plurality of host servers, each hosting a plurality of websites, configured to receive a request for one of the plurality of websites from a user and to transmit the requested website to the user in response, the request and response being transmitted via a first communication channel;
an interactive voice recognition device configured to:
receive a call from a user, the call being transmitted via a second communication channel,
interact with the user to authenticate a website, where the website has an artifact,
inquire from the user a description of the artifact and
receive the description of the artifact in response; and
a controller configured to compare the artifact on the website with the description of the artifact from the user and generate an indication to the user based upon the comparison.

17. The system for validating the authenticity of a website of claim 16, further comprising:
a secure network between the controller and the plurality of host servers configured to secure communication between the controller and the plurality of host servers.

18. The system for validating the authenticity of a website of claim 16,
wherein the website includes a user input interface and the interactive voice recognition device is further configured to instruct the user to input information into the user input interface, the input information is received via the first communication channel at one of the host servers of the plurality of host servers,
wherein the interactive voice recognition device is further configured to receive a description of the input information and forward the description to the controller, and
wherein the controller is configured to determine if the information input via the website matches the description of the information, wherein if there is a match, the controller causes the artifact to be displayed on the website.

19. The system for validating the authenticity of a website of claim 18, wherein the controller determines if the information input via the website matches the description of the information by identifying a host server that received the information input via the website from the plurality of host servers and determining if the host server is a correct host server for the corresponding website, wherein if the host server is correct, the controller causes the artifact to be displayed on the website.

20. The system for validating the authenticity of a website of claim 18, wherein the artifact is unique to a session.

21. A computer readable storage medium having a program for causing a computer to execute a method for validating the authenticity of a website comprising:
receiving a description of an artifact on a website via a first communication channel, the website being displayed on a user equipment via a second communication channel;
comparing the artifact on the website with the description of the artifact; and
generating an indication to the user based upon the comparing.

22. A computer readable storage medium having a program for causing a computer to execute a method for validating the authenticity of a website comprising:
displaying a user input interface on the website;
receiving a description of information input into the user input interface; and
searching a plurality of host servers for matching information, if there is a match,
determining a corresponding host server; and
comparing the corresponding host server with a host server that is hosting the website, if the corresponding host server is the host server that is hosting the website,
displaying an artifact on the website;
receiving a description of the artifact on the website;
comparing the displayed artifact with the description of the artifact; and
generating an indication to the user based upon the comparing of the artifact on the website with the description of the artifact.
